(19) United States
(12) Patent Application Publication
(10) Pub. No.: US 2026/0175986 A1
(43) Pub. Date: Jun. 25, 2026

(54) AIRCRAFT PROPULSION ASSEMBLY HAVING A JET ENGINE, A PYLON AND MEANS FOR ATTACHING THE JET ENGINE TO THE PYLON

(71) Applicant: Airbus Operations SAS, TOULOUSE (FR)

(72) Inventors: Jérôme CASSAGNE, TOULOUSE (FR); Alexandre BELLANGER, TOULOUSE (FR)

(21) Appl. No.: 19/426,729

(22) Filed: Dec. 19, 2025

(30) Foreign Application Priority Data
Dec. 23, 2024 (FR) FR2415160

(51) Int. Cl. B64D 27/40; B64D 27/18

(52) U.S. Cl. CPC B64D 27/402; B64D 27/18

(57) ABSTRACT

An aircraft propulsion assembly having a jet engine with a front casing, a primary structure with a lower spar, two outer rods, wherein each one has a rear end mounted in an articulated manner on the lower spar and a front end mounted in an articulated manner on the front casing, and two inner rods, wherein each one has a rear end mounted in an articulated manner on the lower spar and a front end mounted in an articulated manner on the front casing. Also an aircraft with such an assembly.

### CROSS-REFERENCES TO RELATED APPLICATIONS

This application claims the benefit of French Patent Application Number FR2415160 filed on Dec. 23, 2024, the entire disclosure of which is incorporated herein by way of reference.

### FIELD OF THE INVENTION

The present invention relates to the general field of attaching a jet engine beneath the wing of an aircraft. It relates in particular to a propulsion assembly comprising a jet engine, for example of the un-ducted fan engine type, a pylon and also an attachment assembly intended to attach the jet engine beneath the pylon. It also relates to an aircraft equipped with such a propulsion assembly.

### BACKGROUND OF THE INVENTION

An aircraft conventionally has wings and at least one propulsion assembly fastened beneath each of these wings. Each propulsion assembly comprises an attachment pylon and an engine. The attachment pylon has a rigid structure called the “primary structure” that is fastened between the wing and the engine via attachment assemblies, namely a first attachment assembly between the wing and the attachment pylon and a second attachment assembly between the pylon and the engine.

Although such an engine assembly is effective, developments in jet engines have given rise to the need to design attachment pylons that, inter alia, ensure easy access at the zone of attachment of the jet engine to the attachment pylon.

### SUMMARY OF THE INVENTION

An object of the present invention is to propose a propulsion assembly comprising a jet engine, a pylon and an attachment device intended to attach the jet engine beneath the pylon, which allows easy access to the inside of the zone of attachment of the jet engine to the attachment pylon.

To this end, there is proposed a propulsion assembly of an aircraft, said propulsion assembly having a longitudinal axis and a vertical median plane passing through the longitudinal axis, and having:
a jet engine having a front casing with a rear face perpendicular to the longitudinal axis,
an attachment pylon having a primary structure with a lower spar,
two outer rods disposed on either side of the median plane, wherein each outer rod has a rear end mounted in an articulated manner on the lower spar by a first rear connection point and a front end mounted in an articulated manner on the rear face by a first front connection point, and
two inner rods disposed on either side of the median plane, wherein each inner rod has a rear end mounted in an articulated manner on the lower spar by a second rear connection point and a front end mounted in an articulated manner on the rear face by a second front connection point.

With such an arrangement, the spacing of the rods makes it easier to access the systems housed at the zone of attachment of the jet engine to the attachment pylon.

Advantageously, each connection point takes the form of a pivot connection, of which the axis is perpendicular to the median plane.

Advantageously, the propulsion assembly has an engine attachment between a frontal wall of the primary structure and the front casing.

Advantageously, the engine attachment has a female clevis as one with the frontal wall, a male clevis as one with the rear face and mounted in an articulated manner in the female clevis, a peg as one with the primary structure and of which the axis is parallel to the longitudinal axis, and a housing of the rear face, in which the peg is housed.

Advantageously, the clevises, the peg and the housing are arranged at the median plane.

Advantageously, the peg is as one with the lower spar.

The invention also proposes an aircraft having a wing and a propulsion assembly according to one of the preceding variants, of which the primary structure is fastened beneath the wing.

### BRIEF DESCRIPTION OF THE DRAWINGS

The abovementioned features of the invention, along with others, will become more clearly apparent upon reading the following description of one exemplary embodiment, said description being given with reference to the appended drawings, in which:

FIG. 1 shows a side view of an aircraft according to the invention,

FIG. 2 is a schematic depiction of a propulsion assembly according to the invention in a side view, and

FIG. 3 is a perspective view of a propulsion assembly according to the invention.

### DETAILED DESCRIPTION OF THE PREFERRED EMBODIMENTS

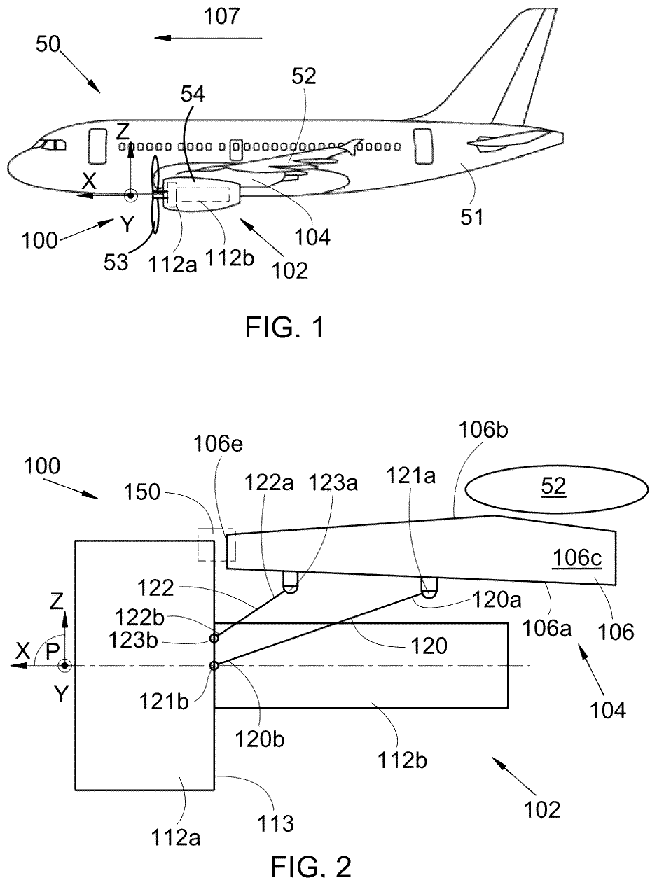

With reference to FIG. 1, an aircraft 50 comprises a fuselage 51 to which is fastened, on each side, a wing 52 beneath which is mounted at least one propulsion assembly 100 according to the invention.

The propulsion assembly 100 comprises an attachment pylon 104 fastened beneath the wing 52 and a jet engine 102 fastened beneath the attachment pylon 104. The jet engine 102 is of the un-ducted fan engine type.

By convention, X denotes the longitudinal axis of the jet engine 102 and therefore of the propulsion assembly 100, this longitudinal axis X being parallel to a longitudinal direction of this jet engine 102. Moreover, Y denotes the transverse axis of the jet engine 102, which is horizontal when the aircraft is on the ground, and Z denotes the vertical axis or vertical height when the aircraft is on the ground, these three directions X, Y and Z being mutually orthogonal.

Moreover, the terms “front” and “rear” are to be considered relative to a direction of forward movement of the aircraft 50 when the jet engine 102 is in operation, this direction being schematically shown by the arrow 107 in FIG. 1.

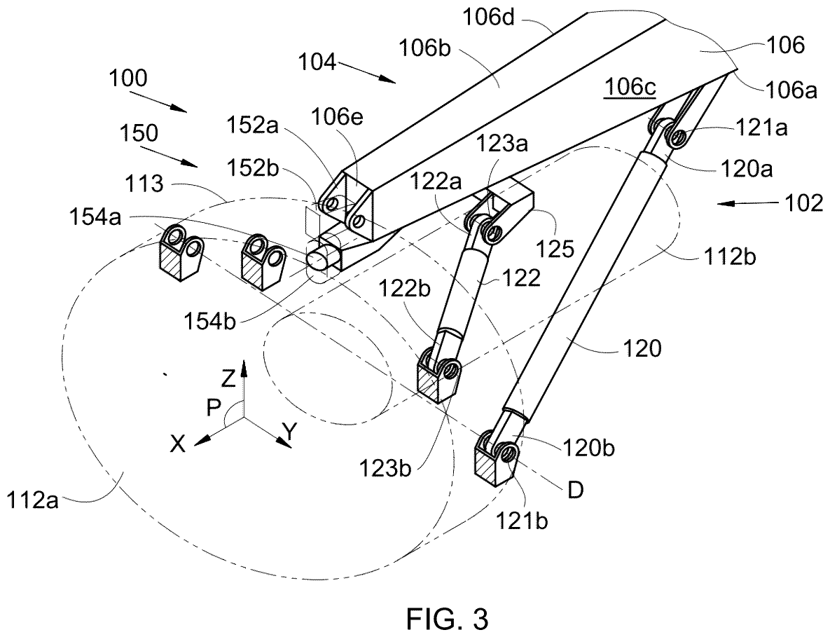

FIG. 2 and FIG. 3 show the propulsion assembly 100 according to the invention.

The jet engine 102 comprises, from front to rear, a propeller 53, a nacelle 54 in which are housed the other elements of the jet engine 102, which take the form of a hub having a front casing 112a and a rear casing 112b that is fastened to the rear of the front casing 112a and in which the other elements of the jet engine 102 are housed, such as compression stages, a combustion chamber, turbine stages and an exhaust cone. The rear casing 112b and the front casing 112a are coaxial with the longitudinal axis X and the rear casing 112b has a diameter smaller than that of the front casing 112a. The rear casing 112b in this case extends from a rear face 113 of the front casing 112a that is perpendicular to the longitudinal axis X.

The attachment pylon 104 is shown here by its primary structure 106 that is fastened to the structure of the wing 52 by any suitable securing means known to those skilled in the art.

The primary structure 106 takes the form of a box that extends in the longitudinal direction X and has a frontal wall 106e, situated at the front of the primary structure 106, a lower spar 106a extending below the primary structure 106 and an upper spar 106b extending above the primary structure 106. The primary structure 106 also has two lateral walls 106c-d on each side of the vertical median plane P. These various spars and walls are fastened to one another to form the primary structure 106.

The attachment pylon 104 and the jet engine 102 are generally symmetrical with respect to a vertical median plane XZ of the propulsion assembly 100 that passes through the longitudinal axis X, which is referred to below as median plane P and separates the attachment pylon 104 and the jet engine 102 into two parts, port-side and starboard-side.

The propulsion assembly 100 also has two outer rods 120 that are disposed on either side of the median plane P. Each outer rod 120 has a rear end 120a that is mounted in an articulated manner on the lower spar 106a by a first rear connection point 121a and a front end 120b that is mounted in an articulated manner on the rear face 113 of the front casing 112a by a first front connection point 121b.

Likewise, the propulsion assembly 100 also has two inner rods 122 that are disposed on either side of the median plane P. Each inner rod 122 has a rear end 122a that is mounted in an articulated manner on the lower spar 106a by a second rear connection point 123a and a front end 122b that is mounted in an articulated manner on the rear face 113 by a second front connection point 123b.

The inner rods 122 are on the inside of the propulsion assembly 100 with respect to the outer rods 120, which are on the outside of the inner rods 122 and extend further towards the rear than the inner rods 122.

The second rear connection point 123a is disposed in front of the first rear connection point 121a.

With such an arrangement, the rods 120 and 122 are spaced apart from the rear casing 112b, allowing easier access towards the inside of the propulsion assembly 100.

In the embodiment of the invention that is presented here, the two front connection points 121b of the outer rods 120 are aligned along a transverse straight line D that is horizontal and therefore in this case parallel to the transverse axis Y.

The transverse straight line D is also, in this case, perpendicular to the median plane P and therefore parallel to the transverse axis Y.

In the embodiment of the invention that is presented here, each connection point 121a-b, 123a-b takes the form of a pivot connection, of which the axis is perpendicular to the median plane P, but a different orientation is possible.

To this end, each connection point 121a-b, 123a-b takes the form of a clevis-type connection, with a male clevis mounted so as to be able to move in rotation in a female clevis via a pin.

For each front connection point 121b, 123b, the female clevis is as one with the rear face 113 and the male clevis is constituted by the front end 120b, 122b of the rod 120, 122 in question.

For each rear connection point 121a, 123a, the female clevis is as one with the lower spar 106a and the male clevis is constituted by the rear end 120a, 122a of the rod 120, 122 in question. In this case, the female clevises of the rear connection points 123a of the inner rods 122 are fastened to a beam 125 as one with the lower spar 106a, which in this case extends laterally beyond the primary structure 106.

To complete the fastening of the front casing 112a to the primary structure 106, the propulsion assembly 100 has an engine attachment 150 that ensures fastening between the frontal wall 106e of the primary structure 106 and the front casing 112a, and more particularly the top part of the rear face 113.

FIG. 3 shows a particular embodiment of the engine attachment 150.

The engine attachment 150 in this case has a female clevis 152a that is as one with the frontal wall 106e, and a male clevis 152b (in faint lines) that is as one with the rear face 113. The male clevis 152b is mounted in an articulated manner in the female clevis 152a via a pin that is not shown. The pin of the clevis connection is perpendicular to the median plane P. The female clevis 152a is mounted at the median plane P, i.e. the two walls of the female clevis 152a are symmetrical to one another with respect to the median plane P.

The engine attachment 150 also has in this case a peg 154a, also called a “spigot”, that is cylindrical and has a first end as one with the primary structure 106 and a second end that projects forwards.

The axis of the peg 154a is in the median plane P and parallel to the longitudinal axis X.

The engine attachment 150 also has a housing 154b made in the rear face 113 and in which the peg 154a is housed. The shape of the housing 154b is such that the peg 154a can move therein parallel to the longitudinal axis X and the vertical axis Z but is blocked parallel to the transverse axis Y.

Such a particular arrangement makes it possible to obtain a system that is statically indeterminate to the 1st degree, which ensures safety, for example in the event of breakage of a rod 120, 122. The clevis connection of the engine attachment 150 reacts the forces in the X direction and in the Z direction and the connection between the peg 154a and the housing 154b reacts the forces in the Y direction. Each rod 120, 122 also reacts the forces along its axis.

As specified above, in the embodiment of the invention shown in FIG. 3, the clevises 152a-b, the peg 154a and the housing 154b are arranged at the median plane P.

In the particular embodiment that is presented here, the peg 154a is secured to the lower spar 106a by fastening an extension of said peg 154a to said lower spar 106a. According to another embodiment that is not shown, the peg 154a may be as one with the frontal wall 106e.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority. Claimed is:

1. A propulsion assembly of an aircraft, said propulsion assembly having a longitudinal axis and a vertical median plane passing through the longitudinal axis, and comprising:
a jet engine having a front casing with a rear face perpendicular to the longitudinal axis;
an attachment pylon having a primary structure with a lower spar;
two outer rods with an outer rod disposed on each side of the median plane, wherein the two outer rods each have a rear end mounted in an articulated manner on the lower spar by a first rear connection point and a front end mounted in an articulated manner on the rear face by a first front connection point; and
two inner rods with an inner rod disposed on each side of the median plane, wherein the two inner rods each have a rear end mounted in an articulated manner on the lower spar by a second rear connection point and a front end mounted in an articulated manner on the rear face by a second front connection point.

2. The propulsion assembly according to claim 1, wherein each connection point comprises a pivot connection having an axis is perpendicular to the median plane.

3. The propulsion assembly according to claim 1, further comprising:
an engine attachment between a frontal wall of the primary structure and the front casing.

4. The propulsion assembly according to claim 3, wherein the engine attachment has a female clevis as one with the frontal wall, a male clevis as one with the rear face and mounted in an articulated manner in the female clevis, a peg as one with the primary structure and having an axis is parallel to the longitudinal axis, and a housing of the rear face, in which the peg is housed.

5. The propulsion assembly according to claim 4, wherein the female clevis, the male clevis, the peg, and the housing are arranged at the median plane.

6. The propulsion assembly according to claim 4, wherein the peg is as one with the lower spar.

7. An aircraft comprising:
a wing; and
the propulsion assembly according to claim 1,
wherein the primary structure is fastened beneath the wing.
